(19) United States
(12) Patent Application Publication
(10) Pub. No.: US 2016/0124580 A1
(43) Pub. Date: May 5, 2016

(54) METHOD AND SYSTEM FOR PROVIDING CONTENT WITH A USER INTERFACE

(71) Applicant: YAHOO ! INC., Sunnyvale, CA (US)

(72) Inventors: Yitian CHEN, Beijing (CN); Siyu ZHU, Beijing (CN)

(21) Appl. No.: 14/410,662

(22) PCT Filed: Jun. 5, 2013
(86) PCT No.: PCT/CN2013/000673

§ 371 Date: Dec. 23, 2014

(51) Int. Cl. G06F 3/0481; G06F 17/30

(52) U.S. Cl. CPC G06F 3/0481; G06F 17/30592; G06F 17/30477

(57) ABSTRACT

Method and system for content presentation are provided. A request is received for content from a user via the communication platform. Content is obtained based on the request. One or more parameters are determined based on information related to the user. The one or more parameters are associated with a user interface (UI) for presenting the content to the user. A UI is generated based on the one or more parameters. The content and the UI are transmitted to the user as a response to the request.

### BACKGROUND

1. Technical Field

The present teaching relates generally to content presentation. More specifically, the present teaching relates to providing content with a user interface (UI).

2. Discussion of Technical Background

The advancement in the Internet has made it possible to make a tremendous amount of information accessible to users located anywhere in the world. With the explosion of information, new issues have arisen. Effort has been made to organize the vast amount of information for responding to a request for information in a more effective and systematic manner.

Since different users can be interested in different information, effort has been made towards identifying a user's interest. Conventional approaches focus only on a user's interest in content to provide personalized content to the user. Hence, existing solutions for identifying a user's interest do not address the user's interest or preference in a user interface that may be used for presenting content to the user. Therefore, there is a need to develop techniques to provide content to a user to overcome the above drawbacks.

### SUMMARY

The present teaching describes methods, systems, and programming for providing content with a UI.

In one example, a method, implemented on a machine having at least one processor, storage, and a communication platform connected to a network for providing content with a UI, is disclosed. A request is received for content from a user via the communication platform. Content is obtained based on the request. One or more parameters are determined based on information related to the user. The one or more parameters are associated with a UI for presenting the content to the user. A UI is generated based on the one or more parameters. The content and the UI are transmitted to the user as a response to the request.

In another example, a system for providing content with a UI is disclosed. The system includes at least one processor, storage, and a communication platform connected to a network. The system comprises a request analysis unit, a content obtaining unit, a user interface generation controller, and a dynamic UI/content transmitter. The request analysis unit is configured for receiving a request for content from a user. The content obtaining unit is configured for obtaining content based on the request. The user interface generation controller is configured for determining, based on information related to the user, one or more parameters associated with a UI for presenting the content to the user, and generating a UI based on the one or more parameters. The dynamic UI/content transmitter is configured for transmitting the content and the UI to the user as a response to the request.

Other concepts relate to software for document update in a database. A software product, in accord with this concept, includes at least one machine-readable non-transitory medium and information carried by the medium. The information carried by the medium may be executable program code data regarding parameters in association with a request or operational parameters, such as information related to a user, a request, or a social group, etc.

In one example, a machine-readable tangible and non-transitory medium having information for providing content with a UI is disclosed. The information, when read by the machine, causes the machine to perform the following. A request is first received for content from a user via the communication platform. Content is then obtained based on the request. One or more parameters are determined based on information related to the user. The one or more parameters are associated with a UI for presenting the content to the user. A UI is generated based on the one or more parameters. The content and the UI are transmitted to the user as a response to the request.

Additional benefits and novel features will be set forth in part in the description that follows, and in part will become apparent to those skilled in the art upon examination of the following and the accompanying drawings or may be learned by production or operation of the examples. The benefits of the present teachings may be realized and attained by practice or use of various aspects of the methodologies, instrumentalities and combinations set forth in the detailed examples discussed below.

### BRIEF DESCRIPTION OF THE DRAWINGS

The embodiments will be more readily understood in view of the following description when accompanied by the below figures and wherein like reference numerals represent like elements, wherein:

FIG. 1 illustrates an exemplary system for providing content with a personalized UI, in accordance with one embodiment of the present teaching;

FIG. 2 illustrates another exemplary system for providing content with a personalized UI, in accordance with one embodiment of the present teaching;

FIG. 3 illustrates an exemplary structure of a user interface database and a user database, in accordance with one embodiment of the present teaching;

FIG. 4 is a block diagram of an exemplary embodiment of a user interface generation controller, in accordance with one embodiment of the present teaching;

FIGS. 5A and 5B are flow charts showing exemplary processes performed by a user interface generation controller, in accordance with one embodiment of the present teaching;

FIG. 6 is a block diagram of an exemplary embodiment of a user interface personalization engine, in accordance with one embodiment of the present teaching;

FIG. 7 is a flow chart of an exemplary process performed by a user interface personalization engine, in accordance with one embodiment of the present teaching;

FIG. 8 illustrates an exemplary decision tree that can be used for determining a UI, in accordance with one embodiment of the present teaching;

FIGS. 9A-9C show some sample UIs for the same content, in accordance with one embodiment of the present teaching;

FIG. 10 depicts a general computer architecture on which the present teaching can be implemented; and

FIG. 11 depicts a general mobile device architecture on which the present teaching can be implemented.

### DETAILED DESCRIPTION

Reference will now be made in detail to the embodiments of the present teaching, examples of which are illustrated in the accompanying drawings. While the present teaching will be described in conjunction with the embodiments, it will be understood that they are not intended to limit the present teaching to these embodiments. On the contrary, the present teaching is intended to cover alternatives, modifications, and equivalents, which may be included within the spirit and scope of the present teaching as defined by the appended claims.

In addition, in the following detailed description of embodiments of the present teaching, numerous specific details are set forth in order to provide a thorough understanding of the present teaching. However, it will be recognized by one of ordinary skill in the art that the present teaching may be practiced without these specific details. In other instances, well-known methods, procedures, components, and circuits have not been described in detail as not to unnecessarily obscure aspects of the embodiments of the present teaching.

Various embodiments in accordance with the present teaching provide method and system related to content presentation. More specifically, the method and system in various embodiments of the present teaching relate to providing content to a user with a personalized UI.

Content is often, if not always, provided to a user in association with a UI. The UI may include parameters like color, brightness, layout, etc. When content is provided to a user, the user's attention can be attracted not only by the content, but also by the UI they are interested in. Different users can have interests in different Uls. Based on user demographics, for example, male users may prefer blue to red, and orange to yellow, whereas female users may prefer red to blue, and yellow to orange. Children may like bright and vibrant colors. The preferences in UI may also be different for users on different operation systems (Mac user, Windows user, etc), or users using different browsers (Firefox, Internet Explorer, etc). Therefore, given same content, a user's attention may be more attracted when the UI associated with the content is personalized based on the user's personal interest.

A user's personal interest in UI may be estimated based on some information related to the user. The information may include the user's age, gender, browser being used, etc. The information related to the user can be pre-stored in a user database or detected based on a request sent by the user. One or more UI parameters can be determined, based on the user's personal interest, to generate a personalized UI for the user. When the personalized UI is provided to the user associated with a website, the user can be attracted to browse the website for a longer time. For example, when the personalized UI is provided to the user by a server and associated with some sponsored search results, e.g., ads, the user can be inspired to click more ads, which may increase the revenue of the server. In addition, the personalized UI can also enhance user experience and attract more users to the server which may be a search engine.

Additional novel features will be set forth in part in the description which follows, and in part will become apparent to those skilled in the art upon examination of the following and the accompanying drawings or may be learned by production or operation of the examples.

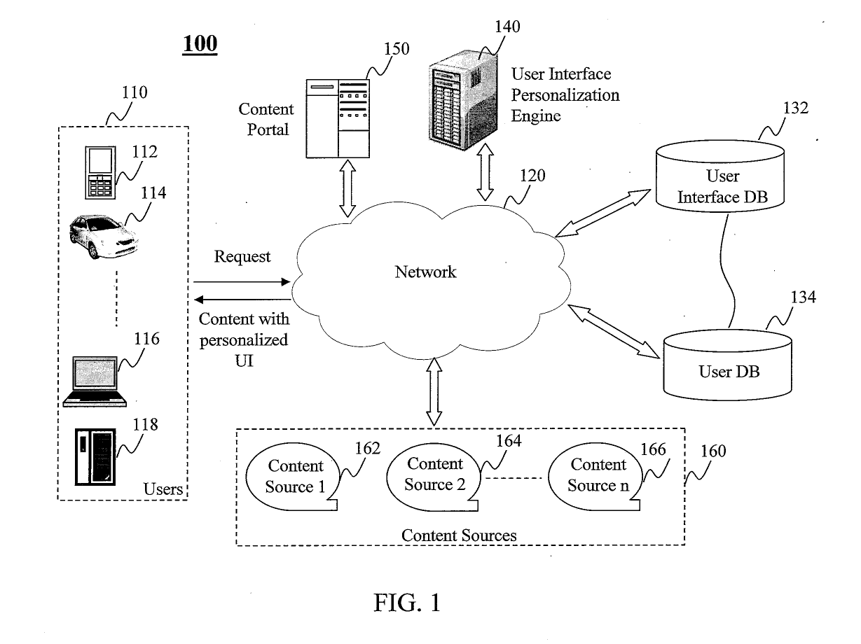

FIG. 1 is a high level depiction of an exemplary system 100 in which a user interface personalization engine 140 is deployed to provide personalized UI, according to a first application embodiment of the present teaching. The exemplary system 100 includes users 110, a network 120, a content portal 150, content sources 160, the user interface personalization engine 140, a user interface database 132, and a user database 134. The network 120 in system 100 can be a single network or a combination of different networks. For example, a network can be a local area network (LAN), a wide area network (WAN), a public network, a private network, a proprietary network, a Public Telephone Switched Network (PSTN), the Internet, a wireless network, a virtual network, or any combination thereof.

Users 110 may be of different types such as users connected to the network via desktop connections (118), users connecting to the network via wireless connections such as through a laptop (116), a handheld device (112), or a built-in device in a motor vehicle (114). A user may send a request to the content portal 150 via the network 120 and receive content from the content portal 150 through the network 120. Along with the content, the user may receive a personalized UI generated by the user interface personalization engine 140. The user interface personalization engine 140 can analyze the information available, e.g., information in the user interface database 132, the user database 134 and the content sources 160, to derive a personalized UI for the user at 110. Such personalized UI may be sent from the user interface personalization engine 140 to the user at 110 via the network 120.

The content sources 160 include multiple content sources 162, 164 . . . 166. A content source may correspond to a web page host corresponding to an entity, whether an individual, a business, or an organization such as USPTO.gov, a content provider such as cnn.com and Yahoo.com, or a content-feed source such as tweeter or blogs. Both the content portal 150 and the user interface personalization engine 140 may access information from any of the content sources 162, 164 . . . 166 and rely on such information to respond to a request.

In the exemplary system 100, a user may send a request to obtain content from the content portal 150. Both the content portal 150 and the user interface personalization engine 140 can receive this request. The content portal 150 may retrieve content based on the request from the content sources 160. In some embodiments, the content is retrieved based on the user's personal interest. The user interface personalization engine 140 can determine a personalized UI for presenting the content to the user. If the user is a registered user, information related to the user may be pre-stored in the user database 134. The user interface database 132 and the user database 134 can be cross indexed to each other, so that for any given user whose information is stored in the user database 134, one or more corresponding parameters associated with a UI can be identified in the user interface database 132 for this user. Thus a personalized UI can be determined based on the parameters corresponding to the registered user. On the other hand, if the user is not a registered user, some dynamic information related to the user can be detected based on the request. For example, the dynamic information may include time, user location, browser being used by the user, etc. Based on the detected dynamic information, a matched profile in the user database 134 can be determined. The matched profile may be associated with a user or a group of users whose information matches well to the detected dynamic information. Then, one or more corresponding parameters associated with a UI can be determined in the user interface database 132 with respect to the matched profile in the user database 134. Thus a personalized UI can be determined based on the parameters corresponding to the non-registered user.

In some embodiments, content retrieved by the content portal 150 may also be utilized to derive the personalized UI. For example, a user may send a query with key words “pink chocolate” to obtain content related to the “pink chocolate”. In this example, the retrieved content may be presented to the user with a pink background or in a pink font, even if the user's stored profile indicates a preference of blue color.

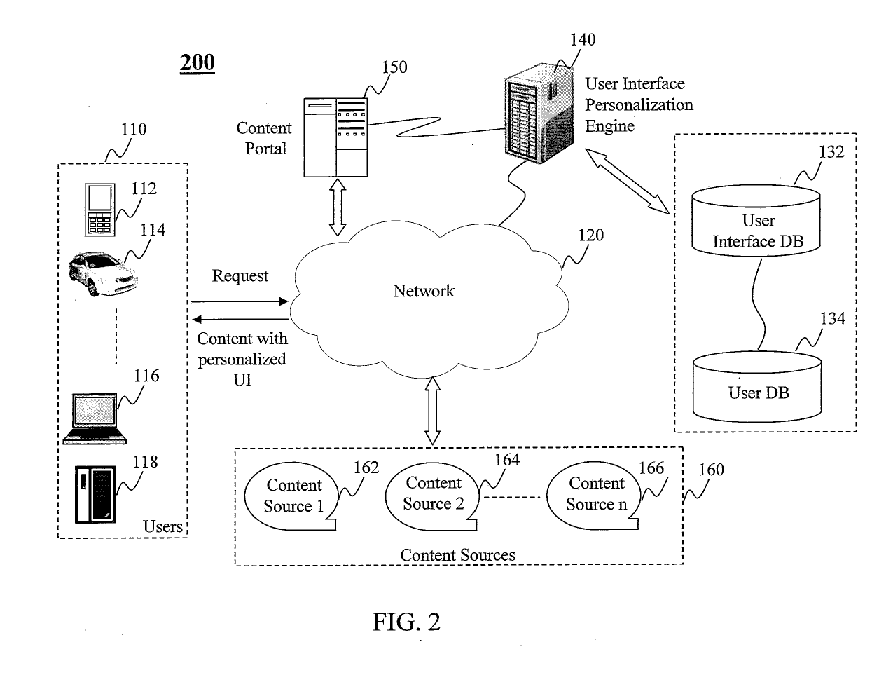

FIG. 2 is a high level depiction of an exemplary system 200 in which a user interface personalization engine 140 is deployed to provide personalized UI, according to a second application embodiment of the present teaching. In this embodiment, the user interface database 132 and the user database 134 serve as backend databases of the user interface personalization engine 140 and connect to the network 120 through the user interface personalization engine 140. In one example, the user interface personalization engine 140 may also serve as a backend system of the content portal 150. Then all requests from users are sent to the content portal 150, which then invokes the user interface personalization engine 140 to provide the personalized UI.

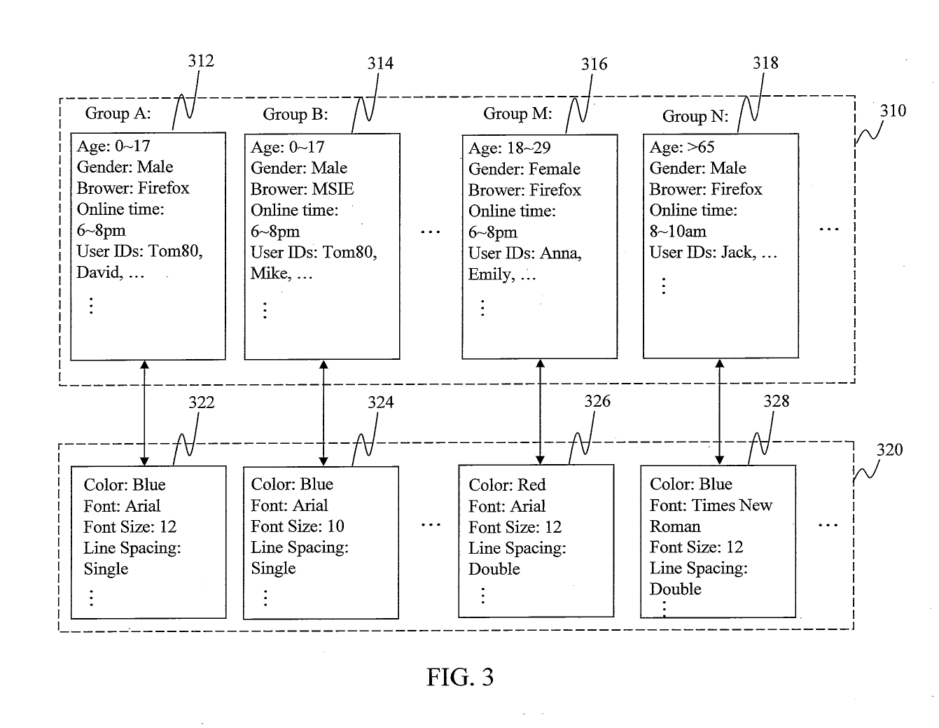

FIG. 3 illustrates an exemplary structure of a user database 310 and a user interface database 320, in accordance with one embodiment of the present teaching. In this example, the user database 310 includes a plurality of user groups comprising, e.g., group A 312, group B 314, group M 316, and group N 318. Each user group may have a group profile to characterize a group of users. For example, each group profile may include age, gender, browser being used, online time, etc. User identifications (IDs) of the users belonging to a group can also be listed in the corresponding group profile.

As shown in FIG. 3, the user interface database 320 may include a plurality of UI profiles 322, 324, 326, 328, each corresponding to a group in the user database 310. Each of the UI profiles may include a set of parameters associated with a UI. The parameters may include color, font, font size, line spacing, layout, and presentation style. The presentation style may indicate how the content is presented, using text, picture, movie, or in combination. The layout may indicate locations and orders of the presented texts and pictures on a displayed webpage.

Each UI profile in the user interface database 320 can be cross indexed with a group profile in the user database 310. In other words, a corresponding group profile can be identified in the user database 310, based on a given UI profile in the user interface database 320; and a corresponding UI profile can be identified in the user interface database 320, based on a given group profile in the user database 310. For example, if a user logged in with a user ID Tom80, group A 312 can be identified in the user database 310 based on the user ID, and the corresponding UI profile 322 can also be identified in the user interface database 320 based on group A 312. Thus, content requested by Tom80 can be provided with a blue color, an Arial font at size 12, single line spacing, or other parameters in the UI profile 322.

In one example, each group in the user database 310 includes only one single registered user with a user ID. When an unregistered user sends a request, a matched profile in the user database 310 of a registered user can be determined based on the request. For example, if the unregistered user browses websites using Microsoft Internet Explorer during 6-8 pm, the profile of a registered user Mike may be determined since Mike has the same behavior as this unregistered user. One or more parameters associated with UI can be determined for the unregistered user, based on the profile of Mike.

In another example, when an unregistered user sends a request, a new profile can be created for the unregistered user in the user database 310. The new profile can be a temporary profile that will expire after the unregistered user becomes offline. The new profile can be a permanent profile if the unregistered user becomes a registered user later. The new profile may record all user behaviors of this user. A new UI profile can also be created accordingly in the user interface database 320, based on the new profile and other profiles in the user database 310. For example, if the unregistered user browses websites using Firefox during 6-8 pm, both group A 312 and group M 316 are matched profiles for this user. The new UI profile can be created by smoothing or combining the two UI profiles 322, 326 corresponding to the two groups 312, 316. For example, the line spacing in the new UI profile may be 1.5, which is an average of the line spacing in the UI profiles 322 and 326. In some scenarios, the user interface personalization engine 140 may randomly select one of the two values, corresponding to one parameter, from the two UI profiles for the new UI profile, e.g., single line spacing from UI profile 322 or double line spacing from UI profile 326. In other scenarios, the user interface personalization engine 140 may select one of the two values, corresponding to one parameter, base on some criteria from the two UI profiles for the new UI profile, e.g., selecting the larger line spacing because it can increase click-through-rate based on history statistics.

In an alternative embodiment, the UI determination is completely individualized. For each user, whether registered or unregistered, there is a corresponding user profile in the user database 310 and a corresponding UI profile in the user interface database 320.

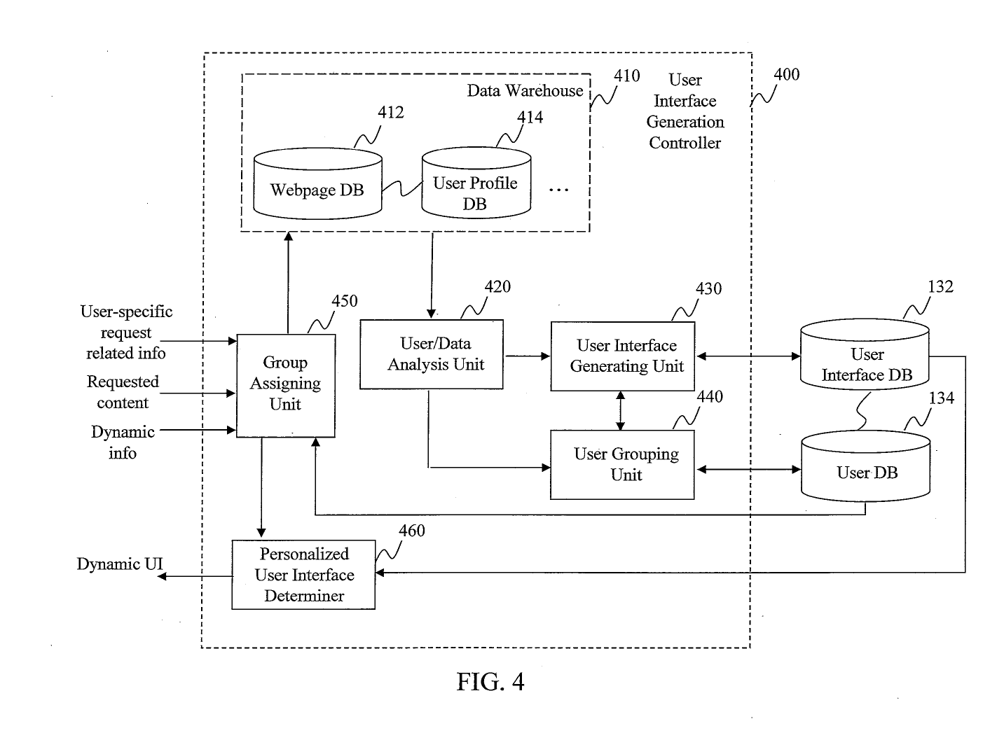

The user database 310 and the user interface database 320 can be created and updated based on information from a data warehouse and an analysis of the user behaviors. The process for creating and maintaining the user database 310 and the user interface database 320 will be described in association with FIG. 4 next.

FIG. 4 is a block diagram of an exemplary embodiment of a user interface generation controller 400, in accordance with one embodiment of the present teaching. In one embodiment, the user interface generation controller 400 may be included in the user interface personalization engine 140 shown in FIG. 1 or FIG. 2. As shown in FIG. 4, the user interface generation controller 400 may include a data warehouse 410, a user/data analysis unit 420, a use interface generating unit 430, a user grouping unit 440, a group assigning unit 450, and a personalized user interface determiner 460. The data warehouse 410 may include many databases, e.g., a webpage database 412, a user profile database 414, etc. The website database 412 and the user profile database 414 can be connected to each other. The databases in the data warehouse 410 may record information based on users' online history data and any sources related to online browsing, searching, etc. In an alternative embodiment, the data warehouse 410 may be located outside the user interface generation controller 400 or may be a shared data warehouse connected to the network 120.

The user/data analysis unit 420 may be configured for collecting information from the data warehouse 410 and analyzing the collected information to determine user behaviors and preferences. For example, the collected information may include user-specific request related information, dynamic information, and the requested content. The user-specific request related information may include at least one of age, gender, user ID, browsing history, and UI preference record. A user's UI preference record may be based on the user's action in response to some UI presented to the user. For example, higher click-through-rate from the user on red texts than blue texts may indicate a preference of red compared to blue, especially when the texts are similar or within one category. The dynamic information may include browser being used by the user, user location, online time, and user device information. In some embodiments, users using different browsers may have different click-through-rate and different preferences on UI parameters, given same content. The user device information may help to determine some preferred UI parameters. For example, a smart phone user may prefer a smaller font size than a personal computer (PC) user.

Based on different user behaviors or preferences, the user grouping unit 440 may be configured for generating a plurality of user groups. Each user group may include one or more users whose behaviors are the same or within a same range. The information related to all users in each user group is recorded as a group profile and stored in the user database 134. The user interface generating unit 430 may be configured for generating a set of UI parameters to each user group generated by the user grouping unit 440. The UI parameters can be generated based on user behaviors. For example, a user group including users using smart phone can be assigned a smaller font size than another user group including users using PC. In some embodiments, a UI parameter can be determined based on weights assigned to each user behavior. For example, if a male user prefers larger font size and a smart phone user prefers smaller font size, the user interface generating unit 430 needs to determine which font size should be chosen for a male smart phone user. The determination of font size in this case may be based on a weighted average of the font sizes in the male user group and the smart phone user group, or based on the font size of the user group having a larger weight. In one scenario, a more specific characteristic may be assigned a higher weight than a less specific characteristic. For example, the smart phone user group can be assigned a higher weight than the male group. Therefore, a male smart phone user can still be assigned a small font size, because although the user is male, he has to view the texts via the small smart phone.

Each set of generated UI parameters associated with a user group may be stored in a UI profile in the user interface database 132. Each UI profile may be cross indexed with a corresponding group profile, as shown in FIG. 3. In one embodiment, when more or new information is collected from the data warehouse 410, the user interface generating unit 430 and the user grouping unit 440 may update some UI profiles and group profiles respectively in the user interface database 132 and the user database 134.

The group assigning unit 450 can be configured for assigning a group for a user, based on information received from the user. For example, when a user sends a query with a key word to the content portal 150 and the user interface personalization engine 140. The user interface personalization engine 140 may receive user-specific request related information and dynamic information from the user, and receive requested content from a content obtaining unit. The content obtaining unit may be located in the user interface personalization engine 140 or in the content portal 150. On one hand, the group assigning unit 450 may send the received information related to the user to the data warehouse 410 to update the information in the data warehouse 410. On the other hand, the group assigning unit 450 can retrieve information from the user database 134 and determine a matched profile in the user database 134 based on the received information from the user. The matching between a profile in the user database 134 and the received information can be determined by finding a profile in the user database 134 that includes all of or the most of the received information among the profiles in the user database 134. In an alternative embodiment, each user has a specific profile in the user database 134. The group assigning unit 450 may directly identify a corresponding matched profile in the user database 134 based on the received information.

The personalized user interface determiner 460 may be configured for determining one or more parameters associated with a UI for presenting the requested content to the user. Once a matched profile is determined in the user database 134, the personalized user interface determiner 460 may retrieve the corresponding UI profile in the user interface database 132 that is cross indexed with the matched profile in the user database 134. The personalized user interface determiner 460 may determine to use a portion or all of the parameters within the retrieved UI profile. For example, when the user is searching for images, the UI parameters like font and line spacing do not apply. The parameters like background color and brightness can be determined by the personalized user interface determiner 460 to present the requested images to the user. The UI determined by the personalized user interface determiner 460 may be a dynamic UI, which can change dynamically based on the user's real time action. For example, if a user stays online for a long time, the online time changes. Based on profiles in the user interface database 132 and the user database 134, users browsing websites during the day and users browsing websites during the night may have different UI preferences. Therefore, the change of online time may change the determined UI at the personalized user interface determiner 460 dynamically.

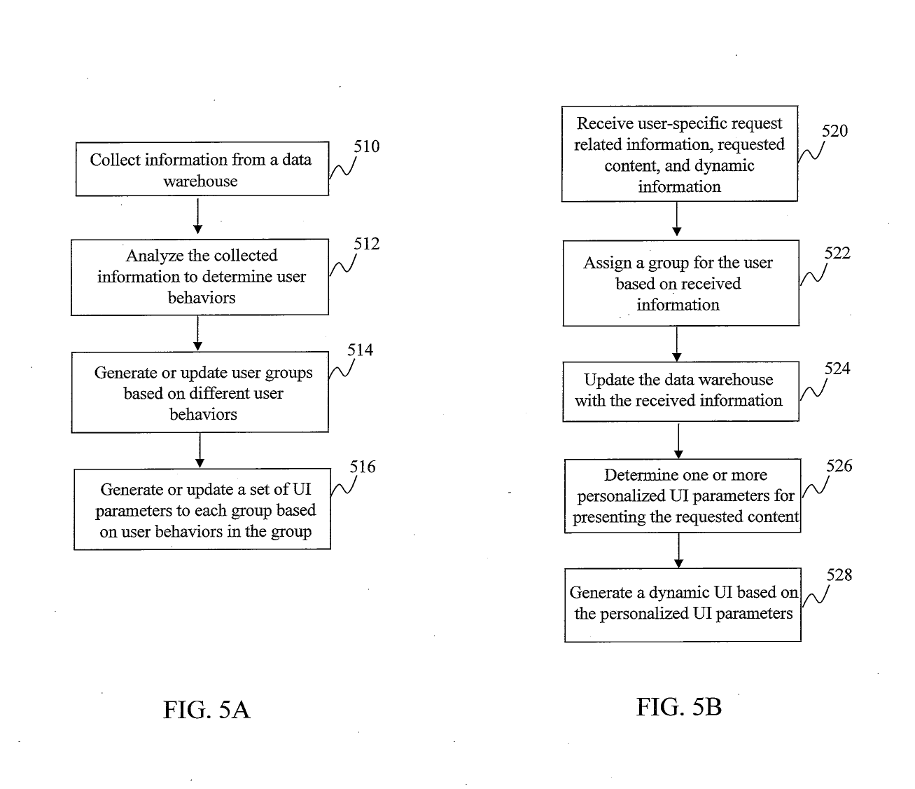

FIGS. 5A and 5B are flow charts showing exemplary processes performed by a user interface generation controller, e.g., the user interface generation controller 400 in FIG. 4, in accordance with one embodiment of the present teaching. FIG. 5A is a flow chart showing an exemplary process that can be continuously performed by the user interface generation controller 400. FIG. 5B is a flow chart showing an exemplary process that can be performed by the user interface generation controller 400 when a request is received from a user.

As shown in FIG. 5A, information can be collected from a data warehouse at 510. The data warehouse may include one or more databases including information related to users and websites. Then at 512, the collected information may be analyzed to determine user behaviors, e.g., browsers being used, online time, etc. At 514, one or more user groups in the user database 134 may be generated or updated, e.g., by grouping different users based on different user behaviors. For example, users using Firefox and user using Microsoft Internet Explorer may be grouped into different user groups. At 516, a set of UI parameters can be generated or updated for each generated or updated user group. For example, if a user changes browser from Firefox to Microsoft Internet Explorer, the profile including or corresponding to the user will be updated to reflect the browser change. Accordingly, some parameters associated with a UI may be updated due to the browser change. For example, the user may be estimated to change color preference from red to blue, based on the icon color of the two browsers. The determined UI for this user can have more blue color and less red color than before.

As shown in FIG. 5B, the user interface generation controller 400 may receive user-specific request related information, requested content, and dynamic information related to a user, at 520. At 522, a group can be assigned for the user based on the received information, e.g., by finding a group whose profile includes all of or the most of the received information among the profiles in the user database 134. At 524, the data warehouse can be updated with the received information. At 526, one or more personalized UI parameters can be determined for presenting the requested content. The personalized UI parameters may be determined based on the assigned group's profile. At 528, a dynamic UI can be generated based on the personalized UI parameters.

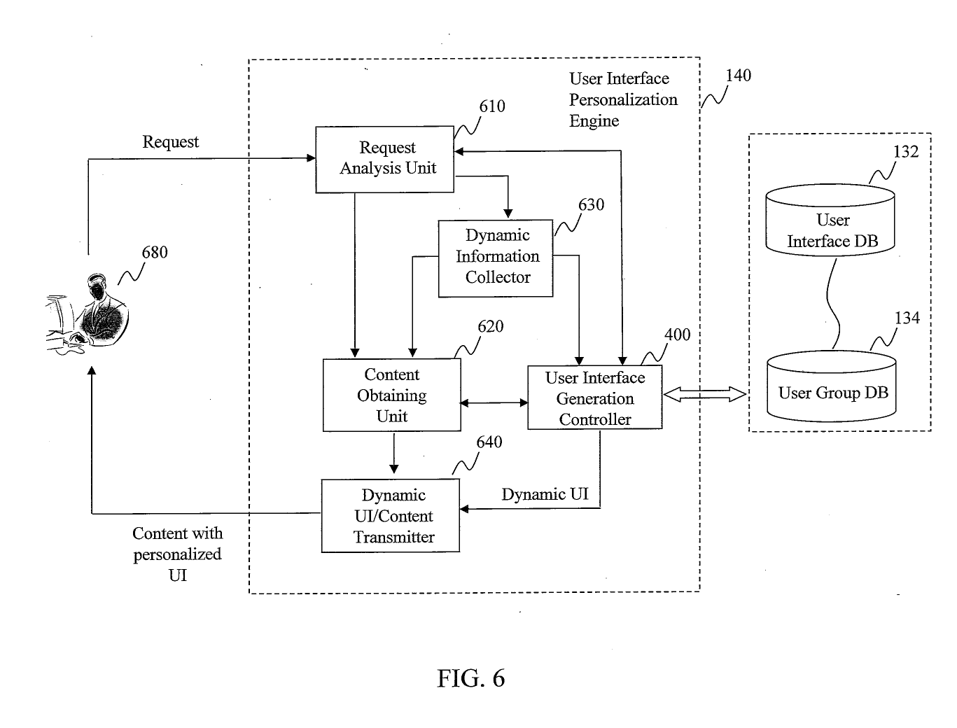

FIG. 6 is a block diagram of an exemplary embodiment of a user interface personalization engine, e.g., the user interface personalization engine 140, in accordance with one embodiment of the present teaching. In this embodiment, the user interface personalization engine 140 may include the user interface generation controller 400 as shown in FIG. 4, a request analysis unit 610, a content obtaining unit 620, a dynamic information collector 630, and a dynamic UI/content transmitter 640. The request analysis unit 610 may receive a request from a user 680 for content and analyze the request to generate some user-specific request related information. The user-specific request related information may include the user 680's age, gender, query, user ID, browsing history, and UI preference record based on history data. Some of the user-specific request related information may be generated based on information in the data warehouse 410 that may be located in the user interface generation controller 400. The dynamic information collector 630 may collect dynamic information continuously about the user 680 and obtain dynamic information based on the user-specific request related information. For example, the user-specific request related information may indicate that the user 680 sent a request that is received at 7 pm. Then dynamic information related to the user 680's online time can be determined based on the received request. The content obtaining unit 620 may obtain content requested by the user 680 from the content resources 160, based on the user-specific request related information and the dynamic information.

As discussed above, the user interface generation controller 400 may generate dynamic UI for presenting the content to the user 680. The dynamic UI may be generated based on the user-specific request related information, the dynamic information, and the obtained content. For example, if the user 680 is searching with key words “Los Angeles Lakers”, content obtained may include a logo of the Los Angeles Lakers team, a link to the official website of the team, and a list of players in the team. Depending on an estimation of the user 680's UI preference, the content may be presented with different layouts, e.g., the logo which is an image or the link which is hypertext may be presented at the top of the returned page in response to the request.

On the other hand, the content obtained at the content obtaining unit 620 may be based on the dynamic UI generated by the user interface generation controller 400. For example, if the user 680 is searching with key words “car” and the dynamic UI indicates that the user 680 prefers the color red, content obtained may include more red cars than cars with other colors.

The dynamic UI/content transmitter 640 may be configured for transmitting the content and the UI to the user 680 as a response to the request. The user 680, upon receiving the content with the personalized UI, may perform some action, e.g., clicking on some returned links or images. Based on the action, another request may be automatically generated and received by the request analysis unit 610.

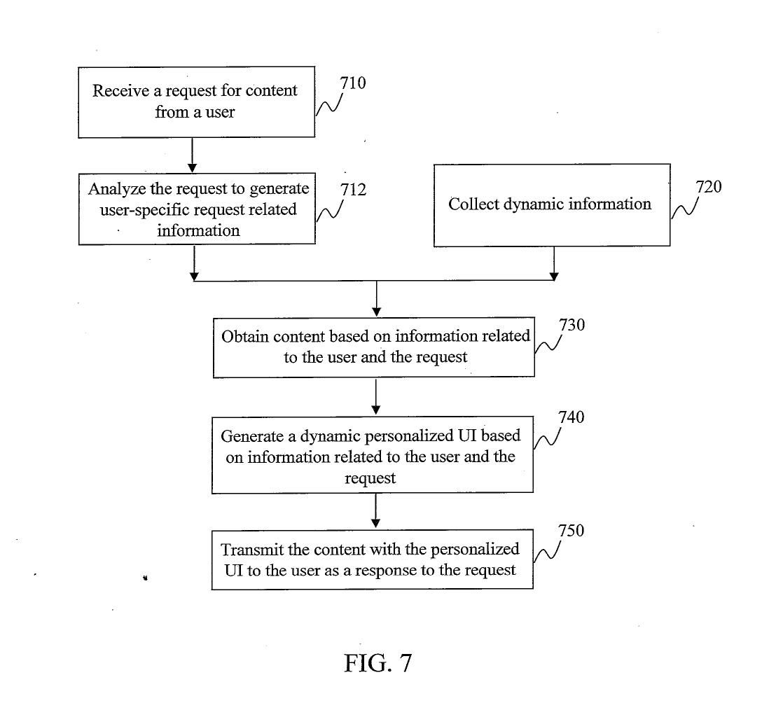

FIG. 7 is a flow chart of an exemplary process performed by a user interface personalization engine, e.g., the user interface personalization engine 140, in accordance with one embodiment of the present teaching. At 710, a request for content may be received from a user. Then at 712, the request may be analyzed to generate user-specific request related information. At 720, dynamic information may be collected at the user interface personalization engine 140. In one example, the 720 may be performed continuously and independent of the 710 and 712. In another example, the 720 may be performed based on the 712. As discussed above, the dynamic information may be obtained at 720 based on the user-specific request related information generated at 712.

At 730, requested content may be obtained, based on information related to the user and the request, e.g., the dynamic information the user-specific request related information. At 740, a dynamic personalized UI can be generated based on information related to the user and the request. As discussed above, the personalized UI can also be generated based on the content. At 750, the content with the personalized UI can be transmitted to the user as a response to the request.

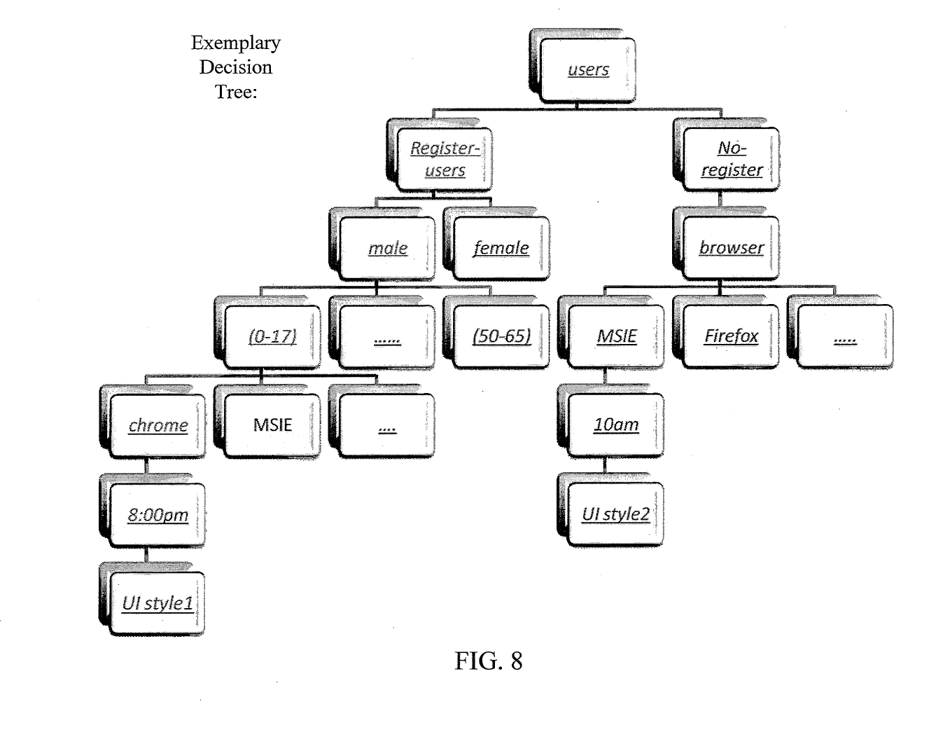

FIG. 8 illustrates an exemplary decision tree that can be used for determining a UI, in accordance with one embodiment of the present teaching. The decision tree may be implemented at the user interface generation controller 400. In this embodiment, when a request is received from a user, it is first determined that whether this user is a registered user or not. If the user is a registered user, for example, the gender and the age range are determined for this user. For example, if the user is a male below 17 years old, then the user interface generation controller 400 may determine which browser he is using and his online time. If he is using Chrome at around 8 pm, a UI associated with style 1 can be determined for this user. The UI style 1 may be updated dynamically based on the user's feedback or actions on the presented content with the UI.

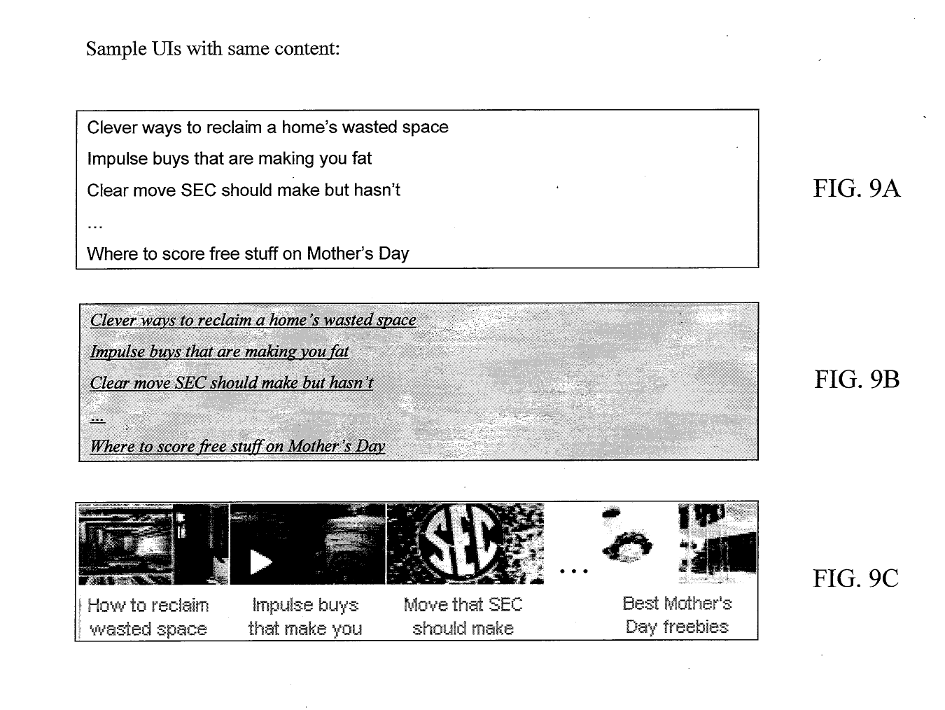

FIGS. 9A-9C show some sample UIs for the same content, in accordance with one embodiment of the present teaching. Each of the FIGS. 9A-9C shows a list of news headlines presented with a type of UI. For example, FIG. 9A shows a list of news headlines with texts in an upright Arial font, ordered vertically. For example, FIG. 9B shows a list of news headlines with texts in an italic “times new roman” font with underlines, ordered vertically. The headlines in FIG. 9B may have a darker background color than the headlines in FIG. 9A. For example, FIG. 9C shows a list of news headlines each with a picture on top of texts, ordered horizontally. The texts in FIGS. 9A-9C may be presented in different colors. When a user sends a request to view these headlines, the headlines can be presented to the user with different types of UIs shown in FIGS. 9A-9C, based on a user group assigned to the user or the user's individual profile.

To implement the present teaching, computer hardware platforms may be used as the hardware platform(s) for one or more of the elements described herein. The hardware elements, operating systems and programming languages of such computers are conventional in nature, and it is presumed that those skilled in the art are adequately familiar therewith to adapt those technologies to implement the processing essentially as described herein. A computer with user interface elements may be used to implement a personal computer (PC) or other type of work station or terminal device, although a computer may also act as a server if appropriately programmed. It is believed that those skilled in the art are familiar with the structure, programming and general operation of such computer equipment and as a result the drawings should be self-explanatory.

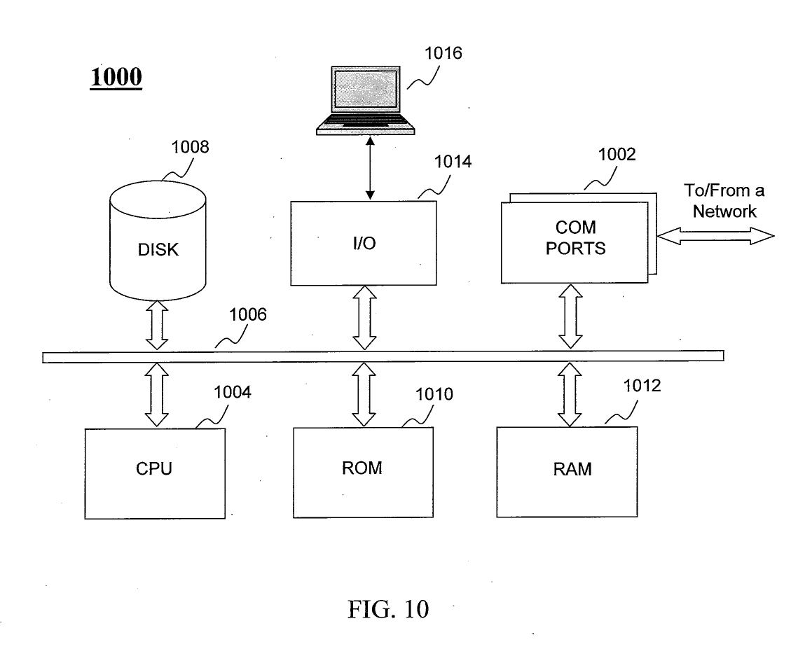

FIG. 10 depicts a general computer architecture on which the present teaching can be implemented and has a functional block diagram illustration of a computer hardware platform which includes user interface elements. The computer may be a general-purpose computer or a special purpose computer. This computer 1000 can be used to implement any components of the system for providing content as described herein. Different components of the system 100 and 200, e.g., as depicted in FIGS. 1 and 2, can all be implemented on one or more computers such as computer 1000, via its hardware, software program, firmware, or a combination thereof. Although only one such computer is shown, for convenience, the computer functions relating to content presentation may be implemented in a distributed fashion on a number of similar platforms, to distribute the processing load.

The computer 1000, for example, includes COM ports 1002 connected to and from a network connected thereto to facilitate data communications. The computer 1000 also includes a central processing unit (CPU) 1004, in the form of one or more processors, for executing program instructions. The exemplary computer platform includes an internal communication bus 1006, program storage and data storage of different forms, e.g., disk 1008, read only memory (ROM) 1010, or random access memory (RAM) 1012, for various data files to be processed and/or communicated by the computer, as well as possibly program instructions to be executed by the CPU. The computer 1000 also includes an I/O component 1014, supporting input/output flows between the computer and other components therein such as user interface elements 1016. The computer 1000 may also receive programming and data via network communications.

Hence, aspects of the method for providing content, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the computer-implemented method.

All or portions of the computer-implemented method may at times be communicated through a network such as the Internet or various other telecommunication networks. Such communications, for example, may enable loading of the software from one computer or processor into another. Thus, another type of media that may bear the elements of the computer-implemented method includes optical, electrical, and electromagnetic waves, such as used across physical interfaces between local devices, through wired and optical landline networks and over various air-links. The physical elements that carry such waves, such as wired or wireless links, optical links or the like, also may be considered as media bearing the computer-implemented method. As used herein, unless restricted to tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

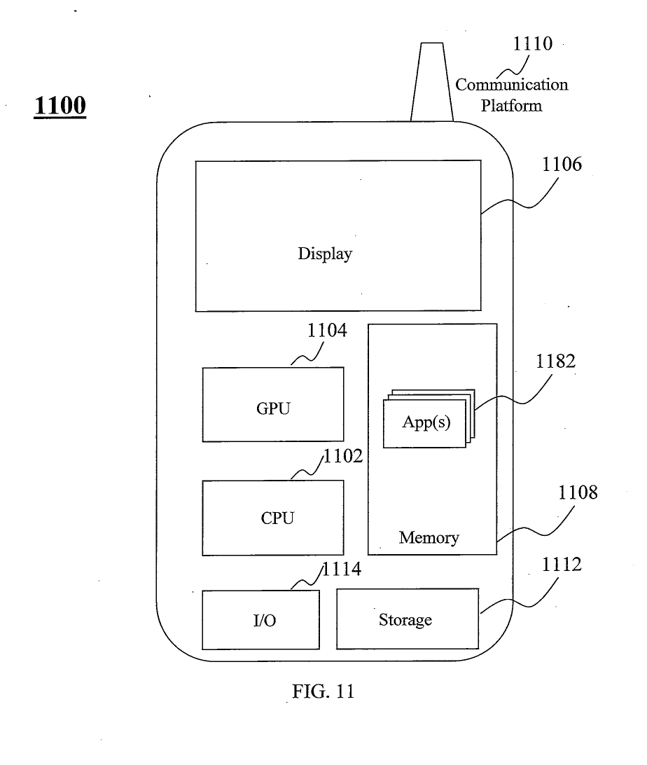

FIG. 11 depicts a general mobile device architecture on which the present teaching can be implemented and has a functional block diagram illustration of a mobile device hardware platform which includes user interface elements. The mobile device may be a general-purpose mobile device or a special purpose mobile device. In this example, the user device is a mobile device 1100, including but is not limited to, a smart phone, tablet, music player, handled gaming console, GPS. The mobile device 1100 in this example includes one or more central processing units (CPUs) 1102, one or more graphic processing units (GPUs) 1104, a display 1106, a memory 1108, a communication platform 1110, such as a wireless communication module, storage 1112, and one or more input/output (I/O) devices 1114. Any other suitable component, such as but not limited to a system bus or a controller (not shown), may also be included in the mobile device 1100. As shown in FIG. 11, one or more applications 1182 may be loaded into the memory 1108 from the storage 1112 in order to be executed by the CPU 1102. The applications 1182 may be executed on various mobile operating systems, e.g., iOS, Android, Windows Phone, etc. Execution of the applications 1182 may cause the mobile device 1100 to perform the processing as described above, e.g., in FIGS. 5A, 5B and 7.

Those skilled in the art will recognize that the present teaching is amenable to a variety of modifications and/or enhancements. For example, although the implementation of various components described above may be embodied in a hardware device, it can also be implemented as a firmware, firmware/software combination, firmware/hardware combination, or a hardware/firmware/software combination.

While the foregoing description and drawings represent embodiments of the present teaching, it will be understood that various additions, modifications, and substitutions may be made therein without departing from the spirit and scope of the principles of the present teaching as defined in the accompanying claims. One skilled in the art will appreciate that the present teaching may be used with many modifications of form, structure, arrangement, proportions, materials, elements, and components and otherwise, used in the practice of the disclosure, which are particularly adapted to specific environments and operative requirements without departing from the principles of the present teaching. The presently disclosed embodiments are therefore to be considered in all respects as illustrative and not restrictive, the scope of the present teaching being indicated by the appended claims and their legal equivalents, and not limited to the foregoing description.

What is claimed is:

1. A method, implemented on a machine having at least one processor, storage, and a communication platform connected to a network for providing content with a user interface (UI), comprising:
receiving, via the communication platform, a request for content from a user;
obtaining content based on the request;
determining, based on information related to the user, one or more parameters associated with a UI for presenting the content to the user;
generating a UI based on the one or more parameters; and
transmitting the content and the UI to the user as a response to the request.

2. The method of claim 1, wherein the one or more parameters comprise at least one of presentation style, color, brightness, font, font style, font size, line spacing, and layout.

3. The method of claim 1, wherein the information related to the user comprises at least one of the following:
user-specific request related information that includes at least one of age, gender, user identification, browsing history, and UI preference record; and
dynamic information that includes at least one of browser being used, user location, online time, and user device information.

4. The method of claim 1, wherein the one or more parameters is determined based on the content.

5. The method of claim 1, further comprising:
collecting information from a data warehouse including information related to one or more users;
analyzing the collected information to determine user behaviors;
generating one or more user groups based on different user behaviors; and
generating a set of parameters associated with UI to each user group based on user behaviors associated with the user group.

6. The method of claim 5, wherein the step of determining the one or more parameters comprises:
determining a user group based on the information related to the user; and
determining one or more parameters associated with a UI based on the set of parameters with respect to the determined user group.

7. The method of claim 1, wherein the request is automatically generated based on an action of the user.

8. A system including at least one processor, storage, and a communication platform connected to a network for providing content with a UI, comprising:
a request analysis unit configured for receiving a request for content from a user;
a content obtaining unit configured for obtaining content based on the request;
a user interface generation controller configured for
determining, based on information related to the user, one or more parameters associated with a UI for presenting the content to the user, and
generating a UI based on the one or more parameters; and
a dynamic UI/content transmitter configured for transmitting the content and the UI to the user as a response to the request.

9. The system of claim 8, wherein the one or more parameters comprise at least one of presentation style, color, brightness, font, font style, font size, line spacing, and layout.

10. The system of claim 8, wherein the information related to the user comprises at least one of the following:
user-specific request related information that includes at least one of age, gender, user identification, browsing history, and UI preference record; and
dynamic information that includes at least one of browser being used, user location, online time, and user device information.

11. The system of claim 8, wherein the one or more parameters is determined based on the content.

12. The system of claim 8, wherein the user interface generation controller comprises:
a user/data analysis unit configured for
collecting information from a data warehouse including information related to one or more users, and
analyzing the collected information to determine user behaviors;
a user grouping unit configured for generating one or more user groups based on different user behaviors; and
a user interface generating unit configured for generating a set of parameters associated with UI to each user group based on user behaviors associated with the user group.

13. The system of claim 12, wherein the user interface generation controller comprises:
a group assigning unit configured for determining a user group based on the information related to the user; and
a personalized user interface determiner configured for determining one or more parameters associated with a UI based on the set of parameters with respect to the determined user group.

14. The system of claim 8, wherein the request is automatically generated based on an action of the user.

15. A machine-readable tangible and non-transitory medium having information for providing content with a UI, wherein the information, when read by the machine, causes the machine to perform the following:
receiving, via the communication platform, a request for content from a user;
obtaining content based on the request;
determining, based on information related to the user, one or more parameters associated with a UI for presenting the content to the user;
generating a UI based on the one or more parameters; and
transmitting the content and the UI to the user as a response to the request.

16. The medium of claim 15, wherein the one or more parameters comprise at least one of presentation style, color, brightness, font, font style, font size, line spacing, and layout.

17. The medium of claim 15, wherein the information related to the user comprises at least one of the following:
user-specific request related information that includes at least one of age, gender, user identification, browsing history, and UI preference record; and
dynamic information that includes at least one of browser being used, user location, online time, and user device information.

18. The medium of claim 15, wherein the one or more parameters is determined based on the content.

19. The medium of claim 18, the information, when read by the machine, further causing the machine to perform the following:
collecting information from a data warehouse including information related to one or more users;
analyzing the collected information to determine user behaviors;
generating one or more user groups based on different user behaviors; and
generating a set of parameters associated with UI to each user group based on user behaviors associated with the user group.

20. The medium of claim 19, wherein the step of determining the one or more parameters comprises:
determining a user group based on the information related to the user; and
determining one or more parameters associated with a UI based on the set of parameters with respect to the determined user group.
